(19) United States
(12) Patent Application Publication
(10) Pub. No.: US 2026/0307743 A1
(43) Pub. Date: Oct. 8, 2026

(54) Sliding Retractable Truck Bed Extender

(71) Applicant: Jack Findley, III, Plum Branch, SC (US)

(72) Inventor: Jack Findley, III, Plum Branch, SC (US)

(21) Appl. No.: 19/349,202

(22) Filed: Oct. 3, 2025

Related U.S. Application Data
(60) Provisional application No. 63/703,638, filed on Oct. 4, 2024.

(51) Int. Cl. B62D 33/08; B60R 11/00

(52) U.S. Cl. CPC B62D 33/08; B60R 11/00; B60R 2011/004; B60R 2011/0059

(57) ABSTRACT

The device is a multi-functional, adjustable truck bed extender that also includes a double T-bar for a variety of uses beyond hauling. The device includes a pair of receivers and extenders connected to the rearward end of the truck with a horizontal double T-bar bar. The receivers are hollow rectangular channels mounted underneath the truck bed. The extenders slide in and out of the receivers for adjustment to load length, and the T-bar is adjustable for load height. Adjustable clamps are provided to lock the extenders and T-bar in place. Optional stabilizer bars may be included for balance and stabilization of the load weight between a tow hitch and the slidable extenders. In addition to providing support for lengthy and larger loads, the device may also serve as a sawhorse, worktable, picnic table or other uses.

### CROSS-REFERENCE TO RELATED APPLICATIONS

This application claims the benefits of U.S. Provisional Patent Application Ser. No. 63/703,638 filed on Oct. 4, 2024, by the present inventor of which all content is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF INVENTION

This invention relates to the motor vehicle field and more particularly to flatbed truck bed slidable extenders in which the extenders slide inside receivers mounted underneath the flatbed truck bed.

### BACKGROUND OF THE INVENTION

It is desirable to extend the length of a truck bed for extended loads that will not fit in the truck bed. A need is identified to make hauling longer materials easier with stability and is easily stowed when not in use. In some cases, this is done by placing retractable extenders inside the tailgate, but the length of the extension is limited by the length of the tailgate. In other cases, this is done by placing separate cage like structures on a lowered tailgate. None of these devices provide sufficient extension that may effectively double the length of the entire truck bed.

### SUMMARY OF THE INVENTION

The present invention comprises a pair of receivers that are securely mounted underneath the truck bed. The receivers and extenders are typically hollow rectangular channels with the extenders having a slightly smaller cross-section. The pair of slidable extenders slide in and out of the receivers to adjust for load length. A double T-bar is attached across the far end of the extenders to adjust for load height. Adjustable clamps are provided to lock the extenders and double T-bar in place. Optional stabilizer bars may be provided for balance and stabilization of the load weight between the tow hitch and the pair of slidable extenders. In addition to providing support for lengthy and larger loads, the invention may also serve as a sawhorse, worktable, picnic table or other uses.

### BRIEF DESCRIPTION OF THE DRAWINGS

Referring now to the drawings in which like reference numbers represent corresponding parts throughout:

FIG. 1 is a perspective view of a embodiment of the flatbed extender of the present invention with the extender in the extended position.

FIG. 2 is a top plan view of the flatbed extender of FIG. 1.

FIG. 3 is a perspective view of the flatbed extender in the unextended position.

FIG. 4 is an enlarged perspective view of the flatbed extender in the extended position.

FIG. 5 is a left side profile view of the flatbed extender in the extended position.

FIG. 6 is a detailed perspective view of the stabilizers and tow hitch.

FIG. 7 is a detailed perspective view of the tow hitch.

FIG. 8 is a detailed perspective view of the left stabilizer.

FIG. 9 is an enlarged perspective view of the flatbed extender in the extended position.

FIG. 10 is a detailed perspective view of the right stabilizer and tow hitch.

FIG. 11 is a detailed perspective view of the connection between the right stabilizer, T-bar, and right stabilizer plate.

FIG. 12 is an enlarged perspective view of the flatbed extender in the extended position.

FIG. 13 is a top plan view of the right interface plate.

FIG. 14 is a top plan view of the left interface plate.

FIG. 15 is an enlarged perspective view of the extenders removed from the flatbed.

FIG. 16 is an enlarged sectional view of the right end of the double T-bar.

FIG. 17 is an enlarged sectional view of the left end of the double T-bar.

FIG. 18 is a bottom cross-sectional view of the right end of the double T-bar.

FIG. 19 is a bottom cross-sectional view of the left end of the double T-bar.

FIG. 20 illustrates an alternate mounting configuration with the receiver channels mounted on top of the flatbed (Top Mount Flat Bed Version).

FIG. 21 illustrates an alternate mounting configuration with the receiver channels mounted inside a pickup bed with the standard tailgate sliding outwards (Tub Style Pickup Bed with Tailgate Extender Version).

FIG. 22 illustrates an alternate mounting configuration with the receiver channels mounted underneath the utility bed (Utility Style Extender Version).

### DETAILED DESCRIPTION OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

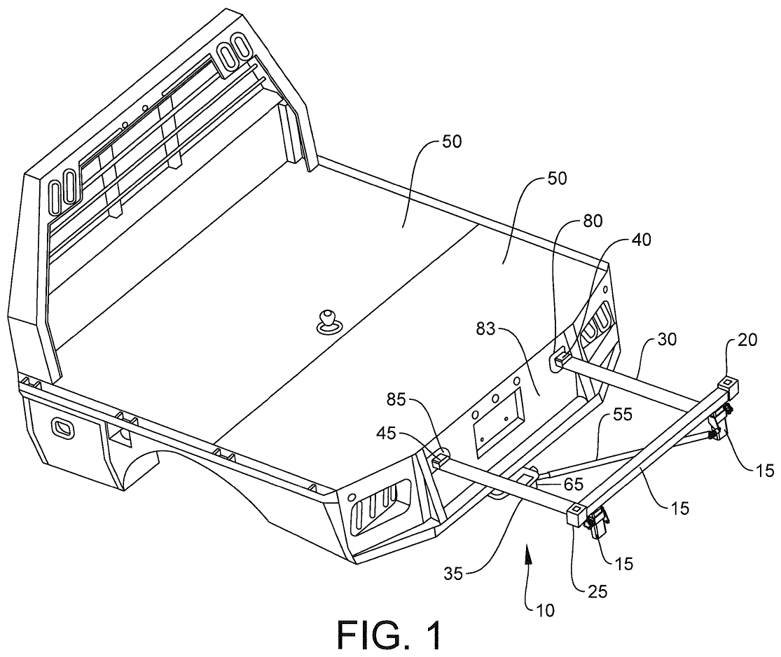

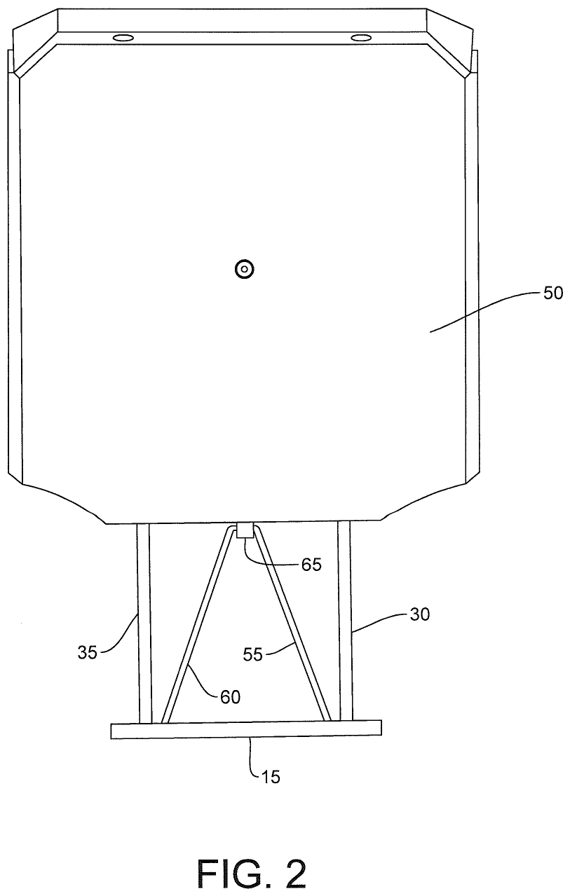

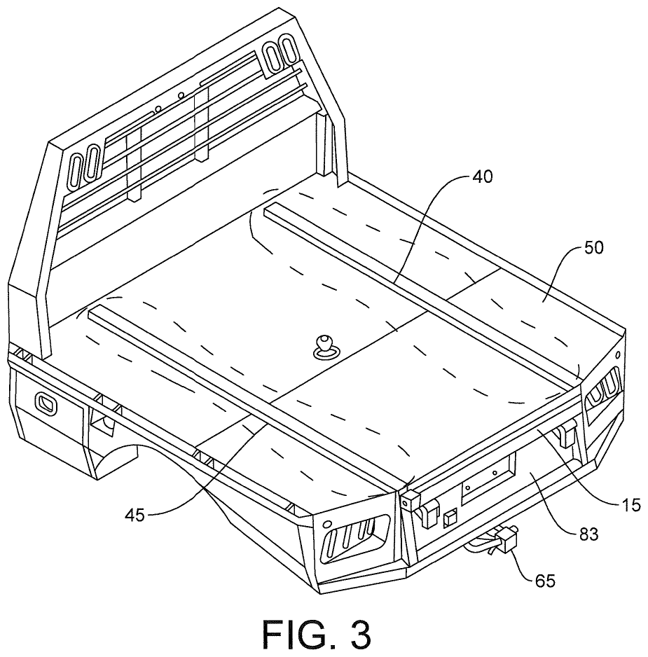

One embodiment of a sliding retractable flatbed extender 10 is illustrated in FIG. 1, FIG. 2, and FIG. 3. The sliding retractable flatbed extender 10 is mounted to the flatbed 50 of a vehicle. The flatbed extender 10 includes a double-T mounting support bar 15; hereinafter referred to as DT-bar 15, which connects to a left slidable extender 35 on one end and a right slidable extender 30 on the other end. The left slidable extender 35 and the right slidable extender 30 are parallel and mirror images to one another and are approximately the same length. The left slidable extender 35 and right slidable extender 30 allow the DT-bar 15 to be slidably moved horizontally towards or away from a rear panel 83 depending on the length of the load. There are two receivers, a left receiver 45 and right receiver 40 installed underneath the bed 50 extending out of the rear panel 83. The left receiver 45 passes through interface plate 85 and the right receiver 40 passes through interface plate 80.

FIG. 1 and FIG. 2 illustrate the flat bed extender 10 in the “fully extended position” whereas FIG. 3 illustrate the flat bed extender 10 in the “shortened position”. The right stabilizer bar 55 and left stabilizing bar 60 (not shown in FIG. 1) are connected to a tow hitch 65. The extender length is reduced by sliding the extenders (30, 35) toward the rear panel 83. The DT-bar 15 is connected to the left accessory receiver 25 and a right accessory receiver 20 on the other end. The accessory receivers (20, 25) may be used to attach an optional miter box, table saw platform, vice or other equipment.

In reference to FIG. 2, the flat bed extender 10 is shown in the “fully extended position”. A left stabilizer bar 60 and right stabilizer bar 55 are optional but provide balance and stabilization of the load weight between the tow hitch 65 and the pair of slidable extenders (30, 35).

As indicated in FIG. 3, the flat bed extender 10 is shown in the “shortened position” with the DT-bar 15 adjacent to the rear panel 83. There are two receivers shown by hidden lines on the bed 50, a left receiver 45 and right receiver 40. The receivers (40, 45) may be secured in place underneath the flatbed 50 surface by welding, brackets or other means. Additionally, in an alternate embodiment of the invention the receivers (40, 45) may be secured in place on the top surface of the bed (50). The tow hitch 65 is shown below the rear of the vehicle.

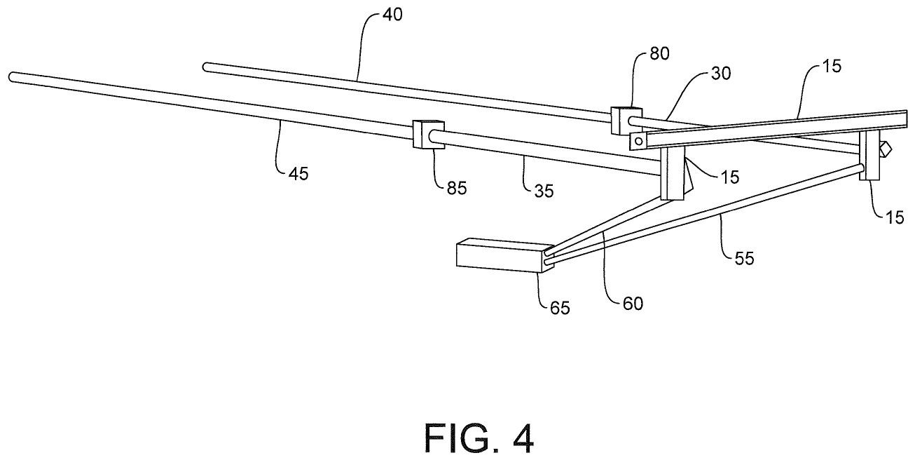

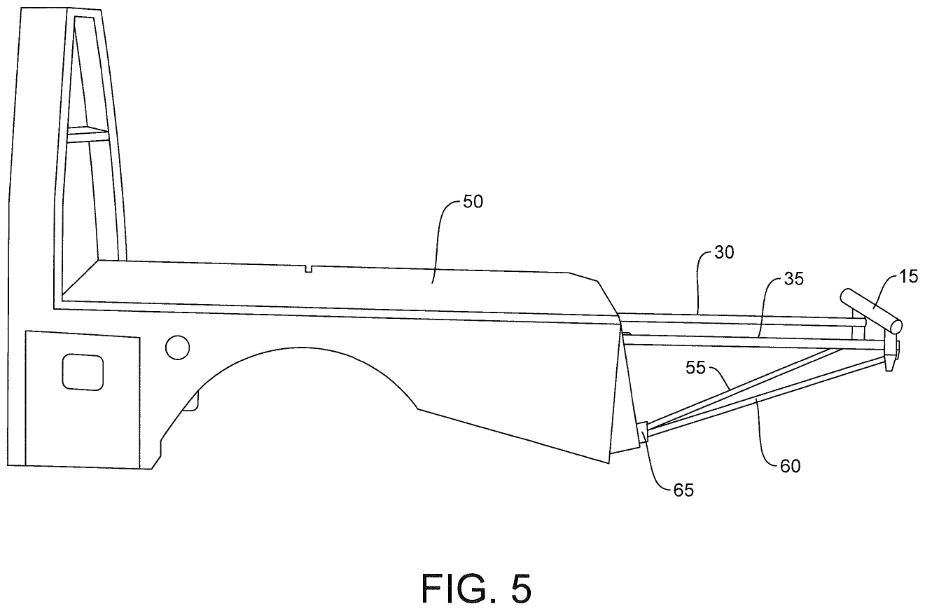

As referenced in FIG. 4 and FIG. 5, the flat bed extender 10 is shown in the “fully extended position”. The left interface plate (85) and a right left interface plate (80) are placed in the rear panel (83). The interface plates (80, 85) support the weight of the receivers (40, 45) and slidable extenders (30, 35) at the rear panel 83. The receivers (40, 45) protrude slightly outward through interface plates (80, 85) on rear panel 83 to accommodate the slidable extenders (30, 35).

The receivers (40, 45) and slidable extenders (30, 35) are typically rectangular steel channels but other shapes are acceptable as long as their different cross-sectional shapes do not interfere with sliding the slidable extenders (30, 35) inside the receivers (40, 45). The slidable extenders (30, 35) slide completely inside the receivers (40, 45) when the DT-bar 15 is in the “shortened position”. The receivers (40, 45) are slightly larger than the slidable extenders (30, 35) in cross-section so receivers (40, 45) can accommodate the slidable extenders (30, 35). The receivers (40, 45) are sufficiently long enough to accommodate the slidable extender (30, 35) lengths. Interface plates (80, 85) at rear panel 83 are provided to support the receivers (40, 45) and slidable extenders (30, 35). The DT-bar 15 connects to the tow hitch 65 via the left stabilizer 60 on the left side and the right stabilizer 55 on the right side. A pair of vertical adjustable DT-bar 15 clamps (41, 42 see FIGS. 16 & 17) allows adjustment of the DT-bar 15 height to match the height of the load. The right slidable extender 30 slides inside right receiver 40. Likewise, the left slidable extender 35 slides inside left receiver 45.

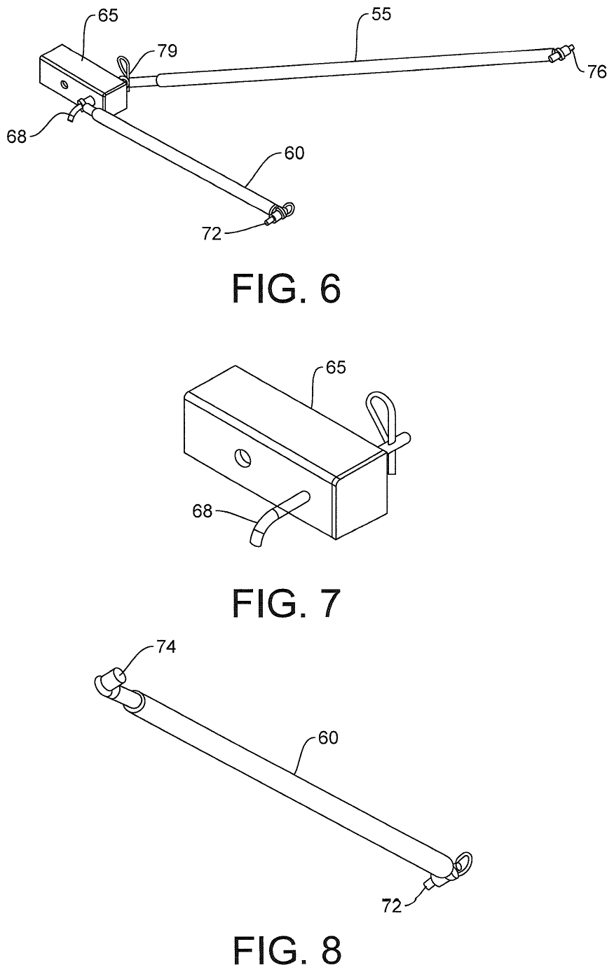

FIG. 6, FIG. 7, and FIG. 8, illustrate the detailed hitch and stabilizer components. FIG. 6 illustrates the details connecting the left stabilizer 60 and the right stabilizer 55 to the tow hitch 65. FIG. 7 shows the tow hitch 65 with hitch pin 68. FIG. 8 illustrates the connection points on each end of left stabilizer 60. The socket 74 on the left stabilizer 60 attaches to the tow hitch 65 through the hitch pin 68. Similarly, the right stabilizer 55 is attached to tow hitch 65 through the hitch pin 68. In FIG. 6, the left stabilizer 60 includes a socket 74 which attaches to the hitch 65 through the hitch pin 68 on one end and attaches to the DT-bar 15 on the other end with a stabilizer bolt 72. The right stabilizer 55 includes a socket 79 which attaches to the tow hitch 65 through the hitch pin 68 on one end and attaches to the DT-bar 15 on the other end with a stabilizer bolt 76.

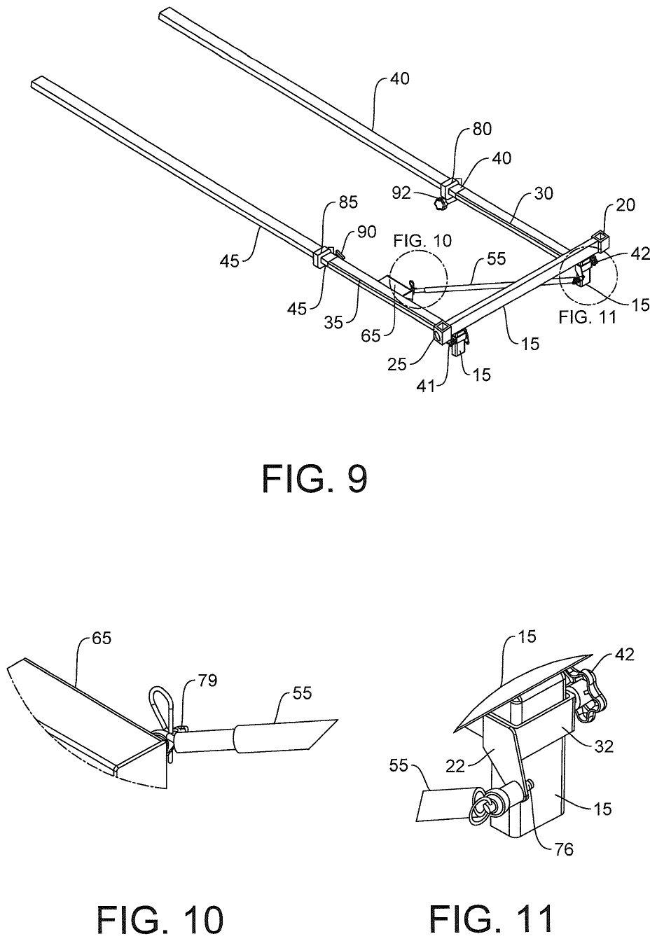

FIG. 9, FIG. 10, and FIG. 11, illustrate the more detailed hitch, stabilizer bars, and DT-bar connections. The load extender is shown in the “fully extended” position. The left interface plate 85 and right interface plate 80 are mounted in the rear panel 83. The left receiver 45 and right receiver 40 are hollow channels which may be a rectangular cross-section. The slidable extenders (30, 35) slide through the respective interface plates (80, 85) into the open receiver channels (40, 45). The open channels (40, 45) slightly extend through the respective interfaces (80, 85) where they may be locked in position by the left adjustable receiver clamp 90 and right adjustable receiver clamp 92. The left adjustable receiver clamp 90 and right adjustable receiver clamp 92 are respectively mounted on left receiver 45 and right receiver 40. The adjustable receiver clamps may be a rotatable knob with a threaded stud to provide a secure clamping force on the slidable extenders (30, 35).

FIG. 10 illustrates in detail of right stabilizer 55 attachment to tow hitch 65 by a hitch pin 68 threaded through socket 79.

In FIG. 11, the right portion of the DT-bar 15 is shown in detail. A right vertical adjustment bracket 32 wraps around the DT-bar 15. The right vertical adjustment bracket 32 is welded to the right slidable extender 30. The DT-bar 15 slides through bracket 32 to aid in adjusting the height of the T-bar 15 to the load. The DT-bar 15 may be locked in position by the right vertical adjustable T-bar clamp 42 and left adjustable DT-bar 15 clamp 41. The vertical adjustable T-bar clamps (41, 42) may be a rotatable knob with a threaded stud to provide a secure clamping force on the DT-bar 15.

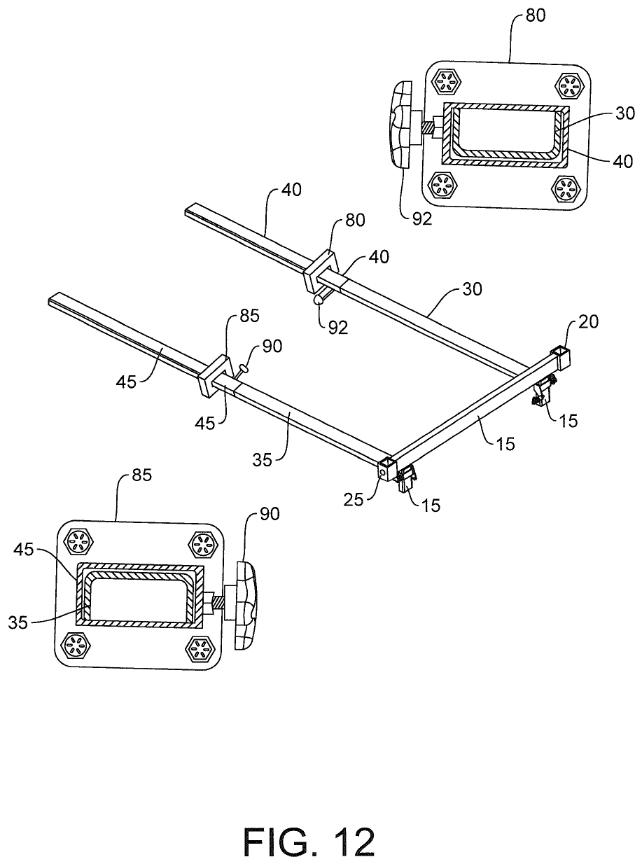

FIG. 12 illustrates the slidable extenders (30, 35) in relation to the receivers (40, 45). Left receiver 45 and right receiver 40 are shown in cross sectional views looking respectively from the rear towards interface plate 85 and interface plate 80. In particular, the left receiver 45 and right receiver 45 are hollow and respectively envelope left slidable extender 35 and right slidable extender 30. The slidable extenders (30, 35) may be locked in position by the left adjustable receiver clamp 90 and right adjustable receiver clamp 92. The adjustable receiver clamps (90, 92) may be a rotatable knob with a threaded stud to provide a secure clamping force on the slidable extenders (30, 35).

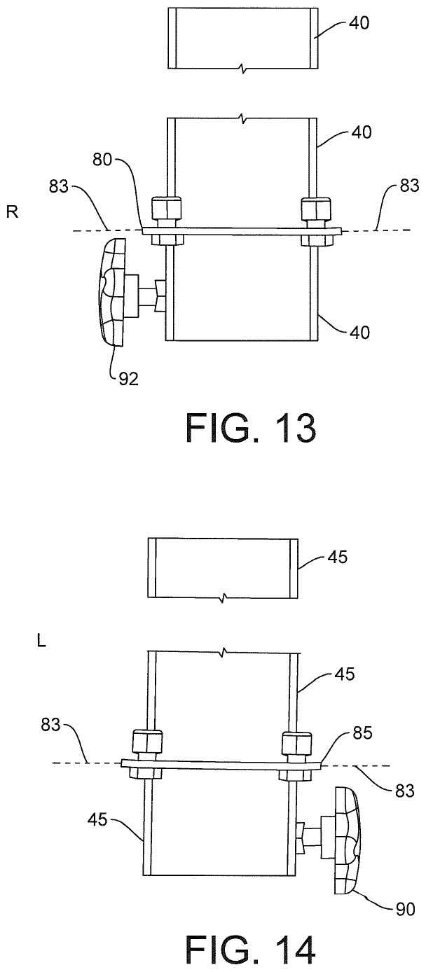

FIG. 13 and FIG. 14 illustrate the relation of the receiver channels (40, 45) to the interface plates (80, 85). The right receiver channel 40 extends from underneath the flatbed to the right interface plate 80. Likewise, the left receiver channel 45 extends from underneath the flatbed to the left interface plate 85. Both right interface plate 80 and left interface plate 85 are mounted in the rear panel 83. the left adjustable receiver clamp 90 and right adjustable receiver clamp 92 are used to hold the slidable extenders (30, 35) in place.

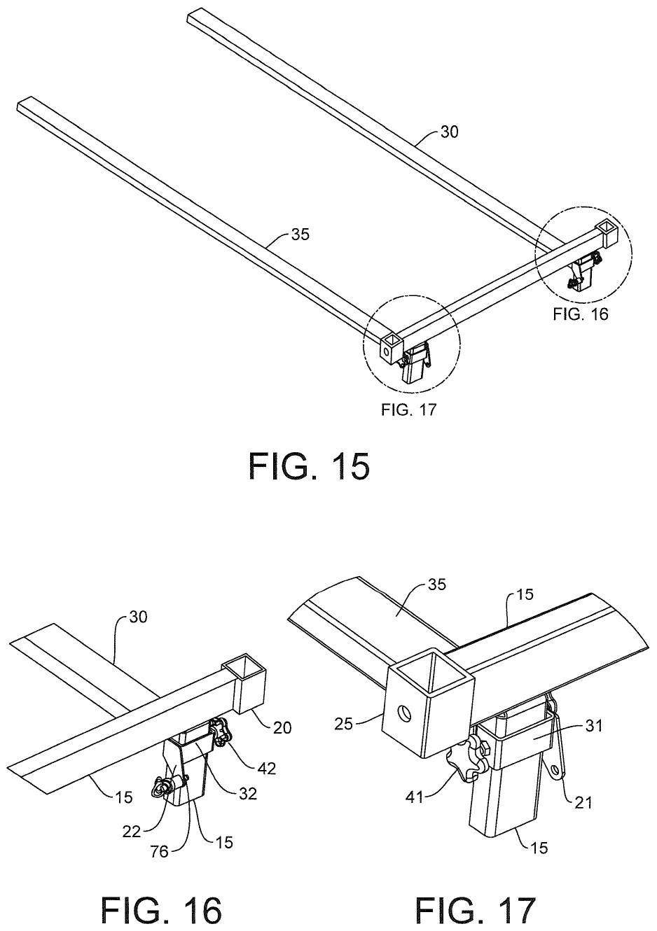

FIG. 15, FIG. 16, and FIG. 17 illustrate the connections of the extenders (30, 35) to the DT-bar 15. FIG. 15 shows the extenders (30, 35) and DT bar 15 removed from the flatbed. The left extender 35 and right extender 30 are connected to the DT-bar 15.

FIG. 16 is an expanded view of the right extender 30 connection to the DT-bar 15. The right accessory receiver 20 is used to attach an optional miter box, table saw platform, or other equipment. A right vertical adjustment bracket 32 wraps around the DT-bar 15. The right vertical adjustment bracket 32 is welded to the vertical right slidable extender 30. The T-bar 15 slides through bracket 32 to aid in adjusting the height of the DT-bar 15. The DT-bar 15 may be locked in position by the vertical right adjustable DT-bar clamp 42 and vertical left adjustable DT-bar clamp 41. The vertical adjustable DT-bar 15 clamps (41, 42) may be a rotatable knob with a threaded stud to provide a secure clamping force on the DT-bar 15. A right stabilizer plate 22 is attached to the right vertical adjustment bracket 32 to insert right stabilizer bolt 76.

FIG. 17 is an expanded view of the left extender 35 connection to the DT-bar 15. The left accessory receiver 25 is used to attach an optional miter box, table saw platform, or other equipment. A left vertical adjustment bracket 31 wraps around the DT-bar 15. The left vertical adjustment bracket 31 is welded to the left slidable extender 35. The DT-bar 15 slides through bracket 31 to aid in adjusting the height of the DT-bar 15. The DT-bar 15 may be locked in position by the vertical right adjustable DT-bar 15 clamp 42 and vertical left adjustable DT-bar 15 clamp 41. The vertical adjustable DT-bar clamps (41, 42) may be a rotatable knob with a threaded stud to provide a secure clamping force on the DT-bar 15. A left stabilizer plate 21 is attached to the left vertical adjustment bracket 31 to insert left stabilizer bolt 72.

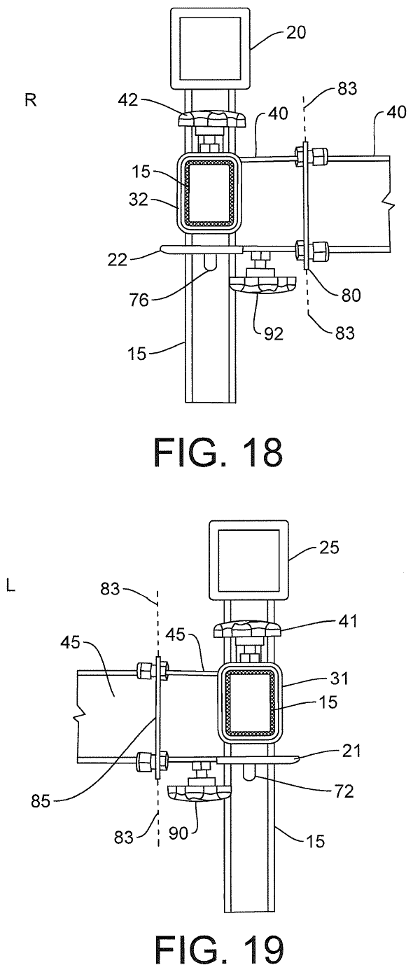

FIG. 18 and FIG. 19 is a bottom cross-sectional view of the extender connections to the DT-bar 15. The views are shown with the extenders (30, 35) in the “unextended position” since the DT-bar is adjacent to the adjustable receiver clamps (90, 92). The right stabilizer bolt 76 and left stabilizer bolt 72 connect the stabilizers and double DT-bar 15 to the tow hitch 65.

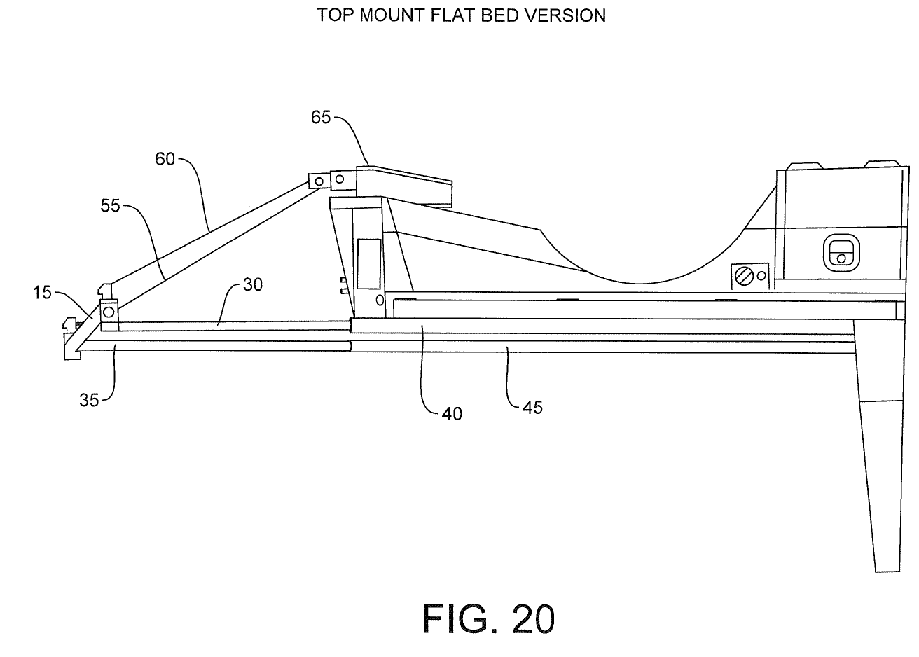

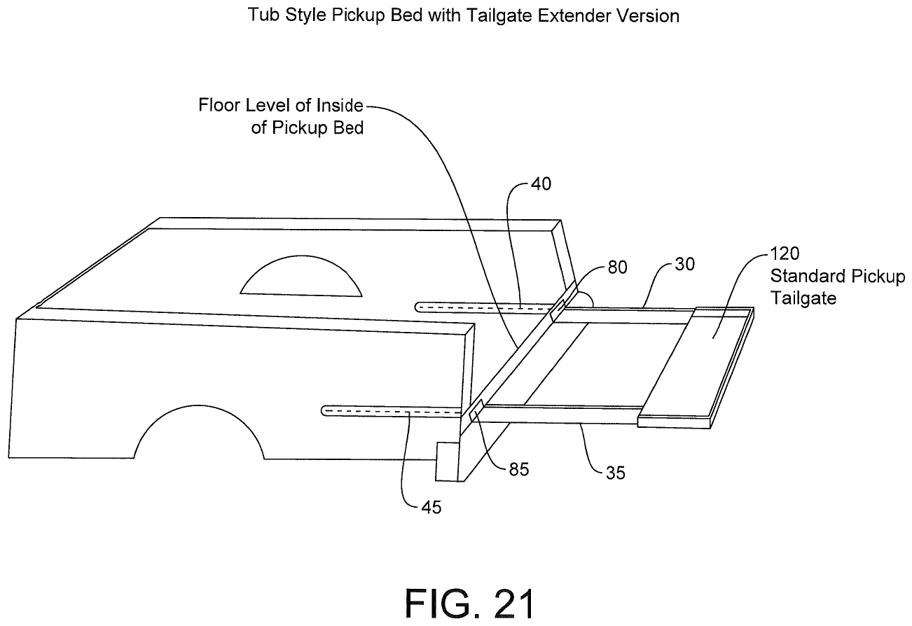

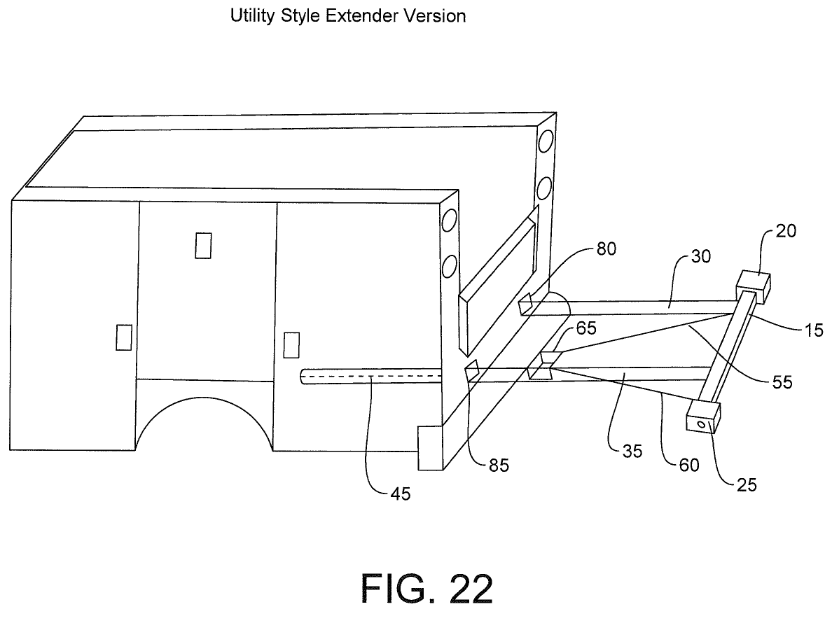

Alternate embodiments of the invention are illustrated in FIG. 20, FIG. 21 and FIG. 22.

In FIG. 20, a top mount flatbed version of the extender is shown. The receiver channels (40, 45) are mounted on top of the flatbed. The slidable extenders (30, 35) are extending outside the receivers. Stabilizer bars (55, 60) are connected from the DT-bar 15 to the tow hitch 65.

In FIG. 21, a tub style pickup bed with tailgate bed extender is shown. The receiver channels (40, 45) are mounted underneath the floor level inside the pickup bed. The extenders (30, 35) slide inside receiver channels via the interface plates (80, 85). A standard pickup tailgate 120 is used in place of the DT-bar 15.

In FIG. 22, a utility style extender version is shown. The receiver channels (40, 45) are mounted underneath the utility bed. The extenders (30, 35) slide inside receiver channels (40, 45) via the interface plates (80, 85). Stabilizer bars (55, 60) are connected from the DT-bar 15 to the tow hitch 65.

In use. one may use the load extender to make it easier to haul loads. Loads may require support due to their extended length. One may haul 16-to-20-foot lengths that are unable to be hauled in standard flatbeds. The load length is estimated, and the extenders (30, 35) are pulled out of the flatbed receivers (40, 45) to the estimated length. The extenders (30, 35) are locked in place with a pair of adjustable receiver clamps (90, 92). A pair of stabilizers (60, 65) may be added to support the load. A pair of vertical adjustable DT-bar clamps (41, 42) allows adjustment of the DT-bar 15 height to match the load. Additionally, the load extender may be used as a sawhorse, worktable, or picnic table for example.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims.

I claim:

1) A truck bed extender comprising:
a) a truck bed;
b) a left interface plate;
c) a right interface plate;
d) a left extender;
e) a right extender;
f) a horizontal T-bar connecting the rearward ends of the left extender and right extender to one another; wherein the T-bar is adjustable for a predetermined height;
g) a left receiver and right receiver securely mounted lengthwise along the truck bed and connecting to their respective interface plate; wherein the left receiver and right receiver are parallel to one another and of equal lengths;
h) a left extender and right extender that are each slidably attached lengthwise to their respective receiver, and wherein the left extender, right extender and horizontal supporting bar move forward or rearward to adjust for a predetermined length.

2) The truck bed extender of claim 1, wherein the said receivers are hollow channels.

3) The truck bed extender of claim 2, wherein the said hollow channels have a slightly larger cross-sectional area to provide a snug and slidable fit for the extenders.

4) The truck bed extender of claim 2, wherein the said receivers have a rectangular cross-section.

5) The truck bed extender of claim 2, wherein the said extenders have a rectangular cross-section.

6) The truck bed extender of claim 1, wherein the said horizonal T-bar has adjustable vertical clamps to lock a predetermined height in place.

7) The truck bed extender of claim 1, wherein the said receivers have adjustable vertical clamps to lock a predetermined length in place.

8) The truck bed extender of claim 1, wherein the said horizonal T-bar has an accessory receiver on each end to attach an optional miter box, table saw platform, vice or other equipment.

9) The truck bed extender of claim 1, wherein the said horizonal T-bar has stabilizer bars on each end connected to a tow hitch.

10. A device extending a truck bed, said device comprising:
a) a truck bed;
b) a pair of interface plates mounted in the rear panel of the truck,
c) a pair of hollow parallel receiver channels of equal length securely mounted lengthwise to the truck bed; wherein the receiver channels extend the length of the truck bed and connected to the rear of the truck at the interface panels;
d) a pair of a smaller cross-sectional parallel extender channels slid inside the receiver channels; wherein the extenders are slidable into and out of the receiver channels;
e) a horizontal double-T support bar is mounted outside the rear of the truck bed connecting the parallel extenders together.

11) The device of claim 10 wherein the said horizonal T-bar has adjustable vertical clamps to lock in a predetermined height in place.

12) The device of claim 10, wherein the said receivers have adjustable vertical clamps to lock in a predetermined length in place.

13) The device of claim 10, wherein the said horizonal T-bar has an accessory receiver on each end to attach an optional miter box, table saw platform, vice or other equipment.

14) The device of claim 10, wherein the said horizonal T-bar has stabilizer bars on each end connected to a tow hitch.

15) A method of extending the length of a truck bed, comprising the steps of:
a) unlocking the adjustable receiver clamps on the left receiver and right receiver;
b) extracting the double-T supporting bar with extenders outward and away from the truck
to a predetermined length necessary to accommodate the load length;
c) locking the adjustable receiver clamps on the left receiver and right receiver;
d) unlocking the vertical adjustable clamps on the left and right side of the double-T bar supporting bar;
e) elevating the double-T supporting bar to a predetermined height necessary to accommodate the load height;
f) locking the vertical adjustable clamps on the left and right side of the double-T bar supporting bar;
g) connecting a right stabilizer bar between the tow hitch and the right stabilizer plate; and,
h) connecting a left stabilizer bar between the tow hitch and the left stabilizer plate.
